(19) United States
(12) Patent Application Publication
(10) Pub. No.: US 2012/0066144 A1
(43) Pub. Date: Mar. 15, 2012

(54) MAP GUIDANCE FOR THE STAFF OF A SERVICE-ORIENTED BUSINESS

(75) Inventors: Winfried Antonius Henricus Berkvens, Eindhoven (NL); Jonathan David Mason, Eindhoven (NL); Evert Jan Van Loenen, Eindhoven (NL); Alexander Sinitsyn, Eindhoven (NL); Simon G. Abernethy, Eindhoven (NL)

(73) Assignee: KONINKLIJKE PHILIPS ELECTRONICS N.V., EINDHOVEN (NL)

(21) Appl. No.: 13/321,554

(22) PCT Filed: May 26, 2010
(86) PCT No.: PCT/IB10/52327

§ 371 Date: Nov. 21, 2011

(30) Foreign Application Priority Data
May 29, 2009 (EP) 09161521.1

(51) Int. Cl. G06Q 10/00; G06Q 50/10

(52) U.S. Cl. 705/345

(57) ABSTRACT

Guidance is provided to a staff of a service-oriented business when catering to a guest on the premises of the service-oriented business. A signal is received from a presence detector on the premises. The signal is representative of a presence of the guest at a pre-determined location on the premises. A length of a time period is determined, during which the guest has been present at the pre-determined location. On a display monitor, a visual indication is generated of the presence at the pre-determined location. The visual indication has an attribute that changes with the passing of time.

### FIELD OF THE INVENTION

The invention relates to a method of providing guidance to a staff of a service-oriented business that is visited by customers or clients, who may need to be attended to by the staff. Examples of a service-oriented business are a hospitality-related business such as a hotel or a restaurant, a retail business such as a department store, or a health-related business such as a health spa or a fitness center. The invention also relates to a system configured for supporting such a method and to control software for implementing an embodiment of such a system.

### BACKGROUND ART

Service-orientated businesses generate revenues by providing services to their customers. If the perceived quality of the service provided is high, the business will create a good impression with their customers, as a result of which the customers will come back, and will tell others about it, thus contributing to establishing and maintaining a favorable reputation and goodwill among the public and eventually increasing the commercial value of the business.

One of the factors, essential to creating the perception of providing a service of a high standard, is that the service provided to any specific customer is initiated at the right moment. For example, it should be avoided that any customer of a restaurant believes he/she has to wait too long before they are being attended to by the staff. As another example, an ongoing, lively conversation between customers in a restaurant should not be interrupted for a second round of refreshments too quickly. As yet another example, when a group of customers leaves the restaurant after having had dinner at a table, this table should be cleaned before one or more other customers sit down at this table. On the other hand, most customers do not like it if a waiter comes over to them too quickly, as they may start feeling as if they were forced to place an order before having settled. As still another example, a customer, who has been browsing the shelves in a certain area of a department store for some time, may wish to consult a shop-assistant for advice on an article of interest.

### SUMMARY OF THE INVENTION

If the staff of the service-oriented business is experienced, they may know intuitively when to approach which customer in order to initiate the service. However, in a crowded area it is fairly difficult for a human being to keep track of each customer's mood or intentions, as is apparent from their body language, or to optimize the distribution of the staffs attention between the customers given each customer's individual needs.

The inventors have therefore formulated the following problem to be solved: how can one support the staff of a service-oriented business with detecting, in a non-obtrusive, customer-friendly manner, when there is a need to provide what service to which customer without having the staff to continuously monitor the entire area? For example, many hotels have very large lobbies and outdoor accommodation, e.g., an outdoor restaurant that gets very crowded at some hours. This presents some problems when catering to the guests. A first problem is that it is difficult to keep track of guest movements in a large and crowded environment. In addition, different members of the staff present may be responsible for carrying out different servicing tasks. As a result, staff members need to communicate with each other so as to keep each other informed. A second problem is that staff members cannot always overlook the entire lobby, the entire floor of the department store or the outdoor restaurant, from a single location, such as the reception desk of a hotel or the cashier's register, and therefore can easily miss some guests.

The inventors propose the following solution. Position one or more detectors in the area, room or hall to be monitored, e.g., a hotel lobby, a dining area of a restaurant, etc. Each of the detectors is configured for detecting guest activity in the area of the hall or room covered by that detector. Embodiments of suitable detectors will be discussed below. The detectors provide detector signals that carry information about the activity per location, covered by one or more detectors, within the area. An example of this information is the time period during which a guest has to wait before being attended to by the staff. This information is used to generate an alert indication being provided as feedback to the personnel (e.g., the staff of the hotel). This feedback can be used to determine when to perform certain activities (e.g., provide service to the guests, do the cleaning) in these public areas.

The feedback is given, e.g., in the form of a visual indication via a display monitor showing a map of the public area with indications such as: how crowded it is in the public area; how long people have been waiting in the same location; whether people are leaving; whether people are standing or sitting and so forth. The display monitor may be a central display monitor consulted by each member of the staff. Alternatively, or in addition to the central display monitor, each individual member of the service staff carries around his/her own individual mobile electronic device accommodating a display monitor and a wireless receiver for receiving a signal indicative of the activity per location. Alternatively, or in addition to the central display monitor and/or to the mobile electronic device, each respective location covered by a respective detector has a respective lighting unit, coupled to the detector via a wired or wireless connection for receipt of the detector signal. The lighting unit is visually perceptible by the staff from a distance but is otherwise unobtrusive to the eye of the guests. The state of the lighting unit, e.g., its being on or its being off, or its assuming a certain color, is controlled by the detector and is pre-determined so as to be representative of the location's activity in the sense of the staff's service being needed or not, and if so, what kind of service. For example, the lighting unit comprises an LED (light-emitting diode, a solid-state lighting device) that is hidden underneath a carpet. When the LED is off, no one notices the presence of the lighting unit. If the LED is on, the carpet is illuminated from underneath and the light gets scattered when it exits the carpet's top layer, giving a subtle lighting spot. As another example, the lighting unit is accommodated at the furniture at the location monitored, e.g., underneath the top of a table, or underneath a sidepiece or a stand, or underneath a seat or couch. As yet another example, the lighting unit is accommodated on the ceiling of the indoor area, and radiates light substantially horizontally and of a modest intensity under control of the detector. For completeness, it is remarked here that some parking garages, e.g., the ones at Brussels International Airport, have a respective small light unit mounted above each respective one of the designated parking spots that assumes a red color when occupied, and a green color when available. This light is visible from afar to a driver, who is driving around in the parking garage, looking for a place to park his/her car.

Instead of generating a visual feedback under control of the detector, feedback of another sensory modality, e.g., auditory feedback or tactile feedback, may be generated through a suitable user-interface. For example, each individual member of the staff carries an individual electronic device that is configured for giving tactile feedback under control of the detector. The generation of tactile feedback in a mobile electronic device is known from, e.g., mobile telephones that are equipped with a vibrator, e.g., an electric motor driving a mass mounted eccentric to the motor's shaft. The rate of vibration and the intensity of the vibration can be used to signal to the staff member, for example, that the number of guests in the area serviced by the staff member has exceeded a certain threshold number, that there is a specific guest whose turn it is to be serviced, that there is a specific table to be cleaned, etc.

The feedback, being visual, tactile or of another human sensory modality, facilitates determining when to cater to which customers.

More specifically, the inventors propose a method of providing guidance to a staff of a service-oriented business for attending to a guest on the premises of the business. The method comprises: receiving from a presence detector a signal representative of a presence of the guest at a pre-determined location on the premises; determining a length of a time period during which the guest has been present at the pre-determined location; and generating a human-perceptible indication of the presence of the guest at the pre-determined location, wherein the indication is generated with an attribute that changes with the passing of time.

Accordingly, the presence of a guest at a pre-determined location, e.g., a certain table, a certain chair, a certain location on the premises, is detected via a presence detector. The detector supplies a signal, e.g., via a local wired or wireless network, to a server. The server gathers and keeps track of the signals received from the presence detectors on the premises, thus maintaining an inventory of the guests present. The signals are processed and human-perceptible indications are created in a user-interface of electronic equipment, e.g., visual cues on a display monitor that is available to one or more members of the attending staff. When a specific one of the monitored guests has been present at the location for some pre-determined length of time without having been attended to, an attribute of the indication, associated with this specific guest, changes in order to draw the attention of the servicing staff. For example, if the human-perceptible indication has a visual attribute, the color or shading of the visual indication on a display monitor, changes when time passes. Alternatively, the attribute is simply one of “turned on” and “turned off”. The user-interface, e.g., the display monitor, therefore provides temporal status information for the guests currently present. This temporal status information is displayed and makes clear to the staff at one glance which specific ones among the guests need attendance, in dependence on the color or shading of the associated visual indications.

In an embodiment of the method, the indication comprises a visual signal, the attribute comprises at least one of a color of the visual signal or an intensity of the visual signal, and the indication is generated at least at one of: a display monitor; and a specific one of multiple lighting units that is near a specific location of the guest on the premises.

As mentioned above, the display monitor may comprise a central display monitor for being consulted by each staff member, and/or an individual display monitor at a mobile electronic device of an individual staff member that receives the signal from the relevant presence detector. In addition, or as an alternative, the visual signal is generated by a lighting unit, e.g., a stationary lighting unit, at or nearby the location of the specific guest, and under control of the signal from the presence detector. Accordingly, the user-interface of the electronic equipment of the staff, referred to above, may be implemented as one or more display monitors, one or more lighting units near or at the locations of the guests, etc., or a combination thereof.

In a further embodiment of the method, the method comprises enabling to modify the attribute under control of at least one of the following: detecting a presence of a member of the staff near the guest; receiving a communication from a communication device of a member of the staff near the guest; and a type of service provided to the guest, as indicated in a communication received from a communication device of a member of the staff.

That is, an action of the member of the staff with regard to this guest changes the status of the catering service, e.g., as visually represented at the map on the display monitor. Providing a service to a guest is considered a sequence of steps to be taken by the staff, with a time period between each step and the next. For example, upon having served the main course of a dinner, the diners are to be left on their own before giving the opportunity to order the desserts, or after having served a first round of drinks, the guests will have the opportunity to order a second round after some time has elapsed. That is, the length of time between subsequent services provided to a specific guest or to a specific group of guests may be made dependent on the type of service provided the most recently. For example, a first time interval between serving the first drink to a guest and taking the order for the appetizer, main dish and desert is set to be shorter than a second time interval between serving the appetizer and serving the main dish. And a third time interval between serving the desert and requesting the guest whether or not he/she likes a cup of coffee or tea before bringing the receipt is set to be shorter than the second time interval. The pre-determined lengths of the first, second and third time intervals determine the attributes of the indications given to the staff. Once the interlude has come to an end, the attribute of the relevant visual indication changes in order to alert the staff to the next step due. The guidance system of the invention then also receives input from the servicing staff member about what has been served to the guest (e.g., first drinks, appetizer, main dish, desert) in order to consider the proper time interval to be elapsed before raising an alert for the next service due.

For example, consider the visual indication being generated, under control of the presence detector, by a lighting unit near or at the location of the guest to be serviced. If the waiter appears to cater to this guest, e.g., to take an order, the attribute of the indication, e.g., the color or intensity of the emitted light, a flashing frequency of the emitted light, or the lighting unit being turned on, is changed upon the appearance of the waiter near the guest. This can be implemented by a lighting unit with an interface to receive a signal from the waiter, e.g., from an RF beacon carried by the waiter, from an RFID card intentionally held by the waiter near the interface, or from a handheld RF transmitter or IR transmitter manipulated by the waiter and transmitting an RF command or an IR command, respectively, that is received by the interface. Alternatively, the presence detector may be configured to also detect the presence of the waiter near the guest. This can, for example, be implemented by means of a presence detection system based on one or more cameras for monitoring the premises of the service-oriented business, and a computer carrying out Video Content Analysis on the video captured. Video Content Analysis will be discussed within this context in some further detail under the section “DETAILED EMBODIMENTS” further below. If the computer infers from the Video Content Analysis that the guest is receiving attention from a member of the staff, the computer may signal the lighting unit, e.g., via a wireless or wired connection, to change the service status of this guest and accordingly, change the attribute of the indication. Alternatively, assume that the waiter has come over to the guest, taken the order from this guest and forwarded the order electronically to a register that keeps track of the items to be billed to this guest. The register is a computerized system. The identity of the lighting unit near the guest is representative of the identity of the guest. The register is configured to communicate to the lighting unit near the guest a signal, e.g., via a wired or wireless connection, to change the service status of this guest as a result of the order being registered. The service status corresponds with the attribute of the indication, as illustrated above. A change in service status is then associated with a change in the attribute.

The invention also relates to a guidance system for providing guidance to a staff of a service-oriented business for attending to a guest on the premises of the business. The system comprises: a presence detector configured for supplying a signal representative of a presence of the guest at a pre-determined location on the premises; a timer, coupled to the presence detector and configured for determining a length of a time period during which the guest has been present at the pre-determined location; and a generator coupled to the timer for generating a human-perceptible indication of the presence of the guest at the pre-determined location, wherein the indication has an attribute that changes with the passing of time.

In an implementation of the guidance system, the presence detector, the timer and the generator are physically integrated in a single device that is powered by a battery and configured for autonomous operation. A plurality of such devices is used to cover the premises of the business. Each respective one of the devices detects the presence of a respective one of multiple guests at a respective location, and controls the attribute of the respective indication to signal the service status of the respective guest.

In another implementation, the presence detector, the timer and the generator are different physical entities that communicate with each other, e.g., via a data network. For example, the guidance system comprises a first number of presence detectors, each respective one thereof positioned in a respective location on the premises. The guidance system comprises a second number of generators. The first number may or may not be equal to the second number. A specific presence detector communicates one or more specific signals to a server. Each respective one of the specific signals is representative of the presence of a respective guest within the area covered by the specific presence detector. The server receives the specific signals and controls a respective timer for each respective guest. Each respective timer in turn determines how and/or when to control the attribute of the indication generated by a respective one of the generators associated with the detected presence of the respective guest.

In yet another implementation, the timer is physically integrated with the generator. The timer is controlled via a wired or wireless network interface to a server that receives the signals from the detectors.

Accordingly, the guidance system may take on different configurations depending on, e.g., whether or not it is practical or economical to concentrate two or more of the functionalities of timer, detector and generator in a single physical device, or to spatially distribute two or more of the functionalities and have at least part of the system assume a network configuration.

In an embodiment of the guidance system, the indication comprises a visual signal; the attribute comprises at least one of a color of the visual signal or an intensity of the visual signal; and the generator comprises at least one of: a display monitor; and a specific one of multiple lighting units that is near a specific location of the guest on the premises.

A further embodiment of the guidance system is configured for modifying the attribute under control of at least one of the following: detecting a presence of a member of the staff near the guest; receiving a communication from a communication device of a member of the staff near the guest; a type of service provided to the guest, as indicated in a determined communication received from a communication device of a member of the staff.

In a further embodiment of guidance system, the attribute is representative of a service due to the guest.

### BRIEF DESCRIPTION OF THE DRAWING

The invention is explained in further detail, by way of example and with reference to the accompanying drawing, wherein:

FIG. 1 is a block diagram of a first server-based system in the invention;

FIGS. 2 and 3 are diagrams of a map of e.g. a hotel lobby, rendered on a display monitor;

FIG. 4 is a diagram illustrating the changing attribute of a visual indication on the map;

FIGS. 5, 6 and 7 are further diagrams of the map;

FIG. 8 is a diagram of a second server-based system in the invention;

FIGS. 9, 10 and 11 are diagrams illustrating a usage scenario of the second server-based system; and

FIG. 12 is a process diagram illustrating an embodiment of a method according to the invention.

Throughout the figures, similar or corresponding features are indicated by same reference numerals.

### DETAILED EMBODIMENTS

The inventors propose using detector information from (non-intrusive) detectors in order to determine activity, including presence or absence of guests, in a public area or parts of the public area on the premises of a service-oriented business. As an example of such public area, consider a hotel lobby. The detector signals give, when processed, detailed information about the level of activity at specific locations within this public area. An example of information extracted is the length of time a guest has been waiting or has been present at a specific location. The extracted information is used to provide visual feedback to the personnel, e.g. the staff of the hotel. This visual feedback assists the staff with determining when to perform certain activities with respect to a particular guest, such as providing a service to this particular guest, or cleaning a table, etc. The visual feedback is given via a display monitor that displays, for example, a map of the public area. The map shows, for example, a two-dimensional representation of the public area. The hotel staff then uses this representation in order to be able to navigate the real-life public area and to identify any particular one of the guests present. The map comprises visual attributes that indicate, for example, the distribution of guests on the premises, how long the guests have been waiting at the same location; whether guests are leaving; whether guests are standing or are sitting, etc. This visual feedback provides a dynamic status report about the guests present. The status report is presented as a map with temporal attributes. This manner of presentation renders the status report easy to be checked at one glance. As a result, the personnel can easily determine when to perform what duties.

The information created about the population of guests is based on the signals received from the detectors on the premises. Examples of such detectors are the following.

Pressure detectors are integrated in the furniture and/or in the floor in order to detect the local presence of a guest based on local pressure and/or a change in local pressure. The pressure detectors supply signals indicative of the pressure detected. The signals are communicated wirelessly to an antenna from which the signals are transmitted as data via a data network to a server. The data is processed at the server for being integrated in the status report visualized at the display monitor. In an embodiment, the pressure detectors are mounted in the legs of a chair. The pressure detectors detect the pressure per leg. The distribution of the pressure on the chair among the legs, gives information about the posture of the guests. In order to discriminate between a guest sitting on a chair and a piece of luggage dropped on the chair, the pressure detectors may register small changes in the pressure, indicative of some natural movement of the guest. The pressure signals may be combined with further signals from, e.g., movement detectors, RFID detectors for detecting a presence of a guest based on a RFID tagged hotel keycard, temperature (infrared) detectors, or detectors for detecting whether a door is being opened or is being closed, in order to improve accuracy of the information inferred from the detector signals. Alternatively, instead of the pressure detectors, movement detectors and/or temperature detectors (e.g., based on infrared) are used to generate signals from which the relevant information about occupancy can be inferred. Another example of a detector system is one based on the analysis of video information of the public area, captured via, e.g., a closed-circuit TV (CCTV) system. In such a detector system, cameras are used to capture the video information about the presence of guests that is then communicated via a network to a server for being analyzed under software control. The expressions “Video Analytics” and “Video Content Analysis” have been used to indicate the emerging technology where computer vision is applied to filter and manage real-time CCTV video for, e.g., security or traffic monitoring. The computer has been programmed to use the color of an object, the relative size of the object and the manner wherein the object moves in order to determine whether or not the object is, e.g., a human. Video Content Analysis can also be used in the invention to determine whether or not a person is present in a predetermined location and if so for how long, based on which a signal can be generated to alert the staff to the need of this person to be attended to. Similarly, the detector system based on Video Content Analysis can also be used to determine whether or not a table has to be cleaned, whether or not it is undesirable to cater to the guests in view of an animated conversation going on, etc. Accordingly, presence detectors and presence detection technologies are known in the art and are not discussed here in further detail. What is new here is that the signal from the detector or from the detector system is being used to generate human-perceptible signals, e.g., with a visual attribute on a display monitor, to conditionally indicate to the staff of the service-oriented business that their service is required by a specific guest based on, e.g., the time elapsed since the specific guest sat down.

From the signals supplied by these detectors, following information can be inferred: the number of guests present in the public area or a part thereof; the posture of a guest sitting in a chair in the public area; the posture changes of a guest; whether a guest is arriving or whether he/she is leaving the public area; whether two or more guests belong to the same party, e.g., a married couple or a group of business people; the length of the time period a certain guest has been stationary with respect to the public area, e.g., for how long he/she has been sitting in the same chair or standing near the same table; etc.

The information inferred from the detector signals may be combined with other knowledge, not based on detector signals, to be able to improve the service to the guests. For example, the following additional knowledge can be taken into account: the time of the day; the breaks in a time-schedule of a conference/exhibition being held at the hotel; the expected time of arrival or departure of a group of guests; the time table of trains or busses that are stopping in the vicinity of the hotel; etc.

The combination of the information, obtained via the detectors, and of the additional knowledge can be used to create guidelines to the staff via a map shown on a display monitor. The guidelines are shown in the form of visual attributes that are dynamic in order to represent the current situation, easy-to-understand, and quick to be perceived and absorbed. The visual attributes use, e.g., various colors, shading, animation, etc. Dynamic features and representations are visually represented so that the staff can instantly discriminate between guests, who have been waiting relatively long and other guests, who have been waiting a relatively short time period. The time that a guest is waiting could also be combined with other information inferred from the signals supplied by the detectors and other knowledge, to speed up, slow down, or delay dynamic features and representations of the visual attributes. For example, the visual attributes include pulsating colored discs that transform into pointy triangles if the waiting time increases beyond a certain threshold, or the visual attributes include animated icons or animated graphical representations (avatars) of guests, which show an increasingly angrier body language the longer they have been waiting. Additional feedback such as an audio signal could also be given, when significant changes occur in the state of the lobby or of the area so as to remind the staff to pay attention to the system providing the visualized guidelines. Such a system could provide accurate information about the state of the lobby or of the area at one glance for the staff. Many members of the hotel staff are provided with paging devices or compact communication devices. The invention could also communicate with these devices to provide a vibration alert when attention is required in the lobby. These communication devices, e.g., mobile telephones, could themselves be used to provide the guidelines to a member of the hotel staff insofar these guidelines relate to this member's responsibilities with regard to providing services.

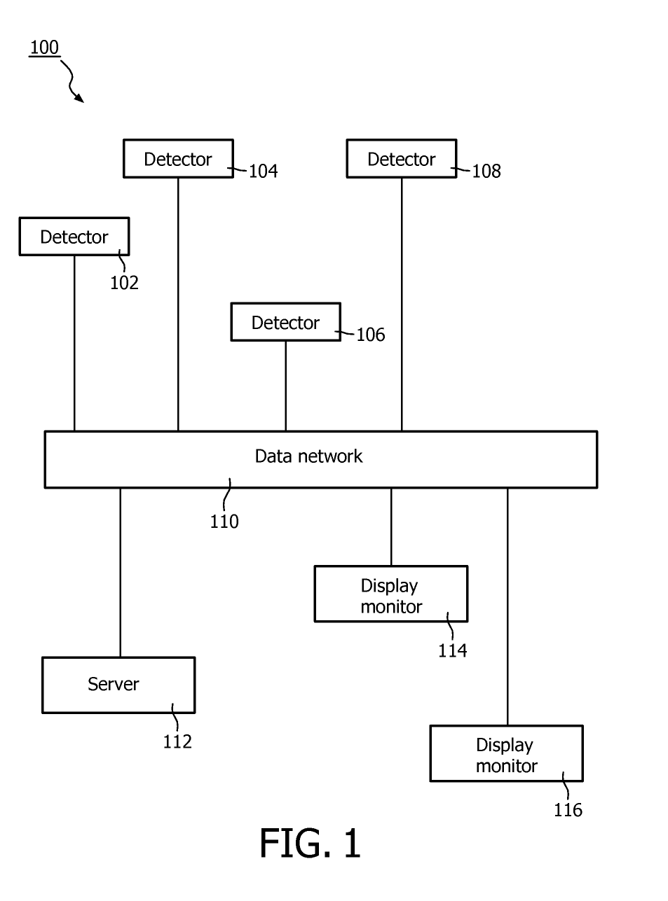

FIG. 1 is a block diagram of a first system 100 in the invention. First system 100 is accommodated at the premises of, e.g., a hotel or another service-oriented business. First system 100 comprises a plurality of detectors 102, 104, 106 and 108. Each of detectors 102-108 is operative to detect the presence of a guest at a particular location on the premises of the business, e.g., in the lobby of a hotel. For example, each respective one of detectors 102-108 detects whether or not a respective one of multiple chairs is occupied by a respective guest. Detectors 102-108 communicate via a data network 110 with a server 112. For example, each of detectors 102-108 transmits a radio signal that is received by an antenna (not shown) of a module (not shown) that converts the signal received into data representative of the state of the monitored chair: a first state “occupied” or a second state “not-occupied”. The data thus created also includes an identifier of the relevant chair. The identifier may be included in the signal transmitted by the detector, or may be added by the receiving module. Each particular of the chairs is located in a particular area of the lobby, so that the data received by server 112 enables to locate the relevant area or even the individual chair within the lobby. The data is sent to server 112 where it is processed under control of a software application. On the basis of the data received from detectors 102-108, server 112 updates a graphical representation of a map of the lobby. The map is accessible for inspection by the hotel staff via one or more display monitors 114 and 116. For example, the lobby, or another control center, has a single display monitor 114 that displays the graphical representation of the map. The display monitor 114 is consulted by all members of the hotel staff in order to check if there is a service due and, if so, where. Alternatively, or in addition, each member of the staff has his/her own display monitor that selectively receives the map updates via a wireless connection from server 112 and via data network 110. Each specific one of the staff members is, for example, responsible for servicing a specific area of the lobby. Accordingly, this staff member receives only updates to the map if relevant to his/her service area. What is needed then is that the staff member's individual display monitor, or his/her wireless communication device comprising the display monitor, is individually addressable. The network address of the staff member's device is then associated with a certain area of the lobby accommodating those chairs from which the detector signals are being used to create guidelines to this staff member in the form of his/her map updates.

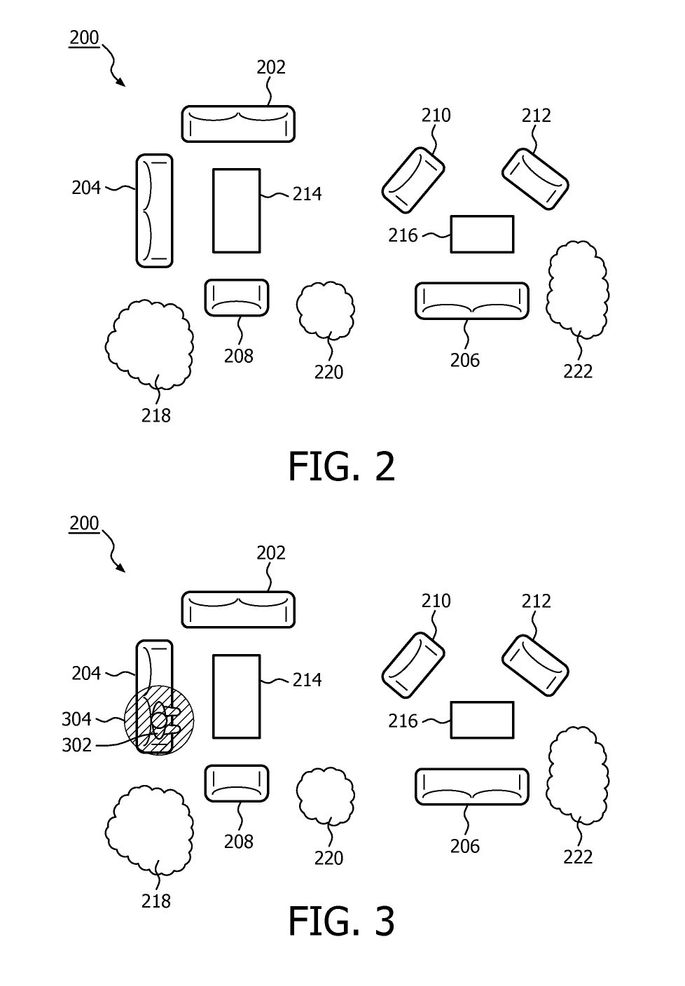

For example, server 112 keeps track of the length of time that an individual chair has been occupied, for all chairs being monitored. If a particular chair has been occupied for longer than a certain length of time, the representation of the particular chair on the map obtains a graphical attribute to as to emphasize this particular chair's state. This will be explained with reference to FIGS. 2, 3 and 4.

It is known in the art how to configure a data processing system for the functionalities specified herein: the communication of data from detectors 102-108 to server 112 via data network 110; the processing of the data at server 112 under control of a software application; the generating of data to control a display monitor such as display monitor 114, and the communication of such data to display monitor 114 via data network 110 (or another network). In the example shown, a (general purpose) server 112 runs a specific software application, stored on a disk, in order to implement the guidance functionality of first system 100. Instead of a general-purpose server 112, one could use another, dedicated, electronic entity programmed or otherwise configured for processing the signals from detectors 102-108 and controlling display monitor 114.

Note that instead of using a plurality of detectors 102-108 at the locations of the guests to display monitors 114 and 116, a detector system could be used, e.g., based on video cameras and Video Content Analysis as discussed above, to control the status information rendered on display monitors 114 and 116 via data network 110

FIG. 2 shows a map 200 of a certain area of the hotel lobby. Reference numerals 202, 204 and 206 indicate graphical representations of different couches present in this area. Reference numerals 208, 210 and 212 indicate graphical representations of different club chairs. Reference numerals 214 and 216 indicate graphical representations of two tables. Reference numerals 218, 220 and 222 indicate different pieces of interior decoration, e.g., different plants.

FIG. 3 shows map 200, but now a relevant one of detectors 102-108 detects a guest 302, who has just sat down on couch 204. The presence of guest 302 is indicated, in the example shown, by means of a colored or shaded disc 304, so as to enable the staff to easily discriminate between occupied locations and non-occupied locations within the service area.

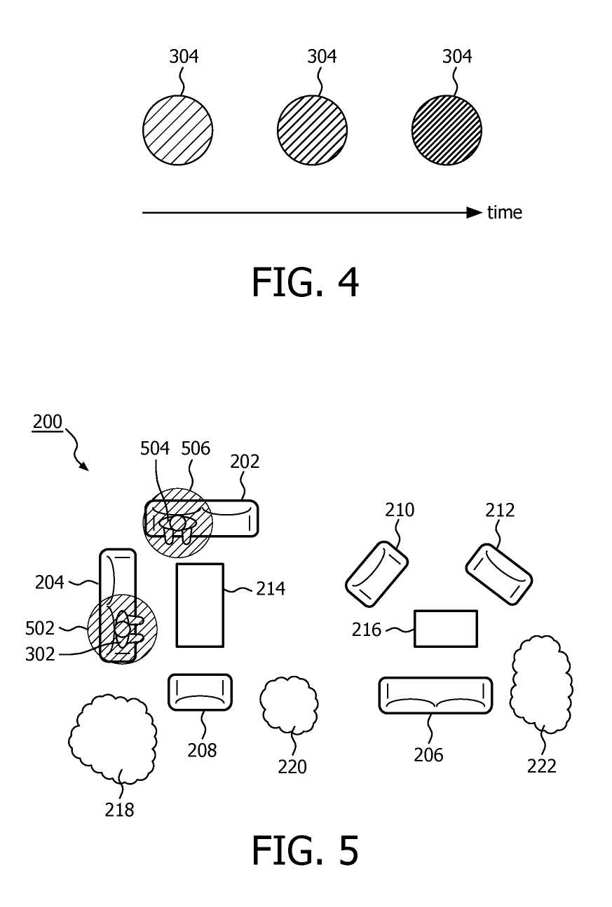

FIG. 4 is a diagram 400 showing disc 304 changing its appearance over time, so as to increasingly more drawing attention from the responsible staff member. For example, the shading of disc 304 becomes more pronounced when time passes, the originally assigned color changes from, e.g., green to red, or the intensity of its color, e.g., red, increases over time, or disc 304 starts out as a semi-transparent shape but becomes more and more opaque over time, etc. Alternatively, or in addition, the size of disc 304 may increase as time passes, or the appearance of disc 304 is intermittent with a frequency that increases as time passes. Any suitable graphical representation of the presence of guest 302 may be chosen that draws increasingly more attention of the staff as time passes.

The idea is that the wait-staff, attending to the guests in the hotel lobby, are enabled to see at a glance, which guests need to be served in order to create the impression of the hotel providing an excellent service. The graphical representation of the lobby area and the graphical attribute that represents the waiting time helps the staff to minimize the length of the time period that a guest has to wait before he/she is being served.

Once a staff member has identified via map 200 a guest, who has been waiting for some time, e.g., guest 302, the staff member goes over to the location of guest 302 to take an order or to otherwise enquire about this guest's wishes. Once the order is taken or delivered or the wishes conveyed, the staff member uses his/her communication device or a user interface at the lobby's central display monitor in order to signal via data network 110 to server 112 that guest 302 has been attended to. The staff member may also communicate to server 112 the type of service provided, e.g., “order taken”, “order delivered”, “just information”, “no service needed”, etc. The staff member may also communicate to server 112 a particular length of a time period that is to elapse, before this guest expects the staff member or another staff member to appear at his/her couch or table, depending on the order taken previously, or on the explicit wishes of the guest upon being asked by the attending waiter. In order to efficiently communicate with server 112, the staff member uses his/her personal communication device equipped with a dedicated user-interface such as a touch screen that gives access to a menu of selectable options. The options include, e.g., the types of services requested, the desired time period between the current service and the next one, etc. In yet another scenario, the staff member carries with him/her a token (not shown), the presence of which is automatically detected, in a wireless fashion, by first system 100 using suitable sensors (not shown) connected to data network 110. The token's presence is registered at server 112. If the token is present at a certain location for more than a pre-determined length of time, server 112 assumes that this implies that the staff member carrying this token has been interacting with a guest at that location. The sensors detect e.g., a radio-frequency response from an RFID tag carried by the staff member and activated by an RF-field (an electromagnetic field having a radio frequency) local to the guest location or a radio beacon carried by the staff member. The response preferably includes the identity of the staff member. Different types of tags can be used to discriminate between, e.g., the cleaning people and the waiters, so as to be able to assume what services are being provided.

Assume that server 100 has determined that a staff member has attended to guest 302.

Server 112 responds by providing on map 200 a graphical representation of the presence of guest 302, e.g., a disc, that now has a non-conspicuous graphical attribute, e.g., a soft color, a safe color (e.g., green instead of red as used above), hazy shading, etc. Alternatively, the graphical representation is omitted altogether until the time elapsed since the order was taken, is longer than a certain threshold. An advantage of having a non-conspicuous graphical attribute over having no attribute at all at this stage, is that the staff member automatically can see that the relevant one of detectors 102-108 and the communication infrastructure between detectors 102-108 and server 112 is operational without any malfunctioning.

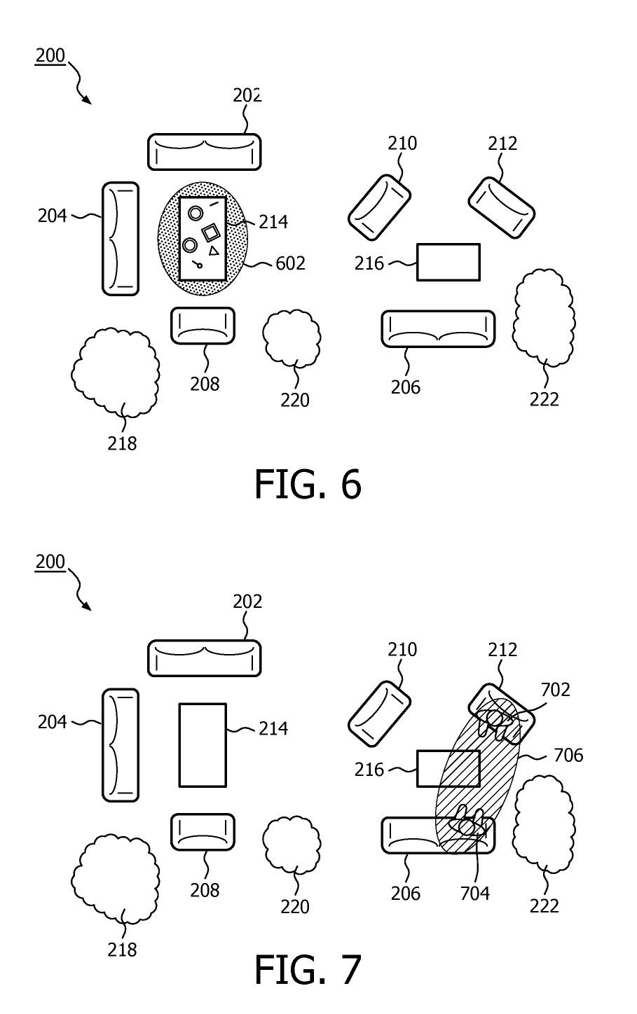

Reference is now had to FIG. 5. Assume that server 112 has determined that guest 302 has now been served and that an order has been taken. First system 100 indicates this on map 200, rendered on a display monitor, e.g., display monitor 114, with a blue disc 502 at the location of guest 302. This blue disc indicates the status: “order has been taken”. This blue disc 502 appears on the display monitor at the moment the waiter has appeared near guest 302, for example in response to first system 100 detecting the RFID tag of the waiter, or in response to an explicit communication from the personal communication device of this waiter to server 112 via data network 110. If guest 302 does not like to order anything at the moment, the waiter explicitly communicates to server 112 that no service was requested, in which case disc 502 is given the color green. In another embodiment server 112 allocates green disc 502 to guest 302 at the moment the waiter arrives for providing his/her service the first time, regardless. In this manner, an explicit communication from the waiter to server 112 is not required in case no order was taken. Each one of the colors blue and green triggers its own time period after which the waiter is alerted to the guest's presence by means of a conspicuous graphical attribute, e.g., a red disc as discussed above.

In the meantime, a new guest 504 has arrived, who is sitting in the same area as guest 302. First system 100 presents a green disc 506 over new guest 504 that changes after a pre-determined length of time into red if this guest 404 has not been served. A similar scenario applies as discussed above with reference to guest 302.

Note that the whole process of serving a guest can be divided in a sequence of steps, depending on this guest's orders. For example, a service consists of first serving an appetizer, then a salad or soup, thereafter a main course, then a dessert, and finally a cup of coffee. As another example, a service consists of first serving a beer, then a beer with a snack, then another beer with more snacks, then a snack with a beer, and finally ordering a taxicab. Each particular one of such steps can be given a particular graphical attribute on map 200, made visible via the display monitor to facilitate checking the progress made in the service provided to this guest. To each particular one of such steps can be allocated a time period of a particular length. The time period is measured from the moment of initiating this step. After elapse of this time period, the next step is due. If the next step is delayed, the graphical attribute changes in order to become more pronounced so as to signal to the wait-staff that the next step is overdue and that this guest needs to be attended.

Reference is now had to FIG. 6. Guests 302 and 504 have now left, leaving behind the usual clutter of plates, glasses, napkins, silverware, etc. The absence of guest 302 and 504 is determined via relevant one of detectors 102-108. Couches 202 and 204 are not occupied. Once this state has been determined by server 112, map 200 allocates a graphical attribute to the area, signifying that this area is ready for being cleaned. In the example shown, a yellow region 602 appears over table 214 on map 200. Again, if table 214 has not been cleaned within a pre-set time, the graphical attribute, here region 602, changes its appearance to convey the message to the staff that the cleaning is overdue. Server 112 is notified of the step of the cleaning itself by means of an explicit message initiated by the member of the cleaning staff via his/her personal communication device. Alternatively, server 112 infers from the presence in the area of a token, carried by the member of the cleaning staff, that the cleaning is being taken care of Server 112 thereupon updates the status of the area and removes the graphical attribute, here yellow region 602, from map 200. Map 200 returns then to the status as depicted in FIG. 2.

As discussed above, the signals supplied by presence detectors 102-108 may also be used to extract information about the posture of a guest sitting in a chair in the public area or about their activities. For example, consider a chair having four legs. Consider further a detector with a load cell positioned between a front leg and the floor, and another detector with another load cell positioned between a rear leg of the chair and the floor. A load cell is configured for registering the weight carried by that load cell and, therefore, by the leg in contact with that load cell. The posture of a guest, sitting in that chair, can be inferred from the weight distribution between the legs. The detectors send the weight, registered by the load cells, to server 112. From the weight registered by the front cell and the weight registered by the rear cell, it is possible to discriminate between the following static postures: sitting straight; sitting backward with stretched legs (relaxed position); and sitting while leaning forward (attention posture). Various methods can be applied to determine the posture based on readings of the load cells.

For example, the ratio of the weight registered by the front load cell and the weight registered by the rear load cell can be compared to threshold values. If the ratio of the front weight and the rear weight is much larger than unity, it is likely that the person is sitting while leaning forward. If the ratio is much smaller than unity, it is likely that the person is sitting backward with his/her legs stretched. If the ratio has a value around unity, it is likely that the person is sitting straight.

As another example, server 112 then calculates a normalized front weight and a normalized rear weight resting on the front leg and rear leg, respectively. The normalized front weight is the ratio of the weight registered by the load cell at the front leg, on the one hand, and the sum of the weights registered by the load cell at the front leg and the load cell at the rear leg, on the other hand. Similarly, the normalized rear weight is the ratio of the weight registered by the load cell at the rear leg on the one hand, and the sum of the weights registered by the load cell at the front leg and the load cell at the rear leg on the other hand. Now, if the difference between the normalized front weight and the normalized rear weight is larger than a first threshold value, it is likely that the person sitting on the chair is leaning forward. If the difference between the normalized rear weight and the normalized front weight is larger than a second threshold value, it is likely that the person sitting on the chair is leaning backward. If the absolute value of the difference between the normalized front weight and the normalized rear weight is smaller than a third threshold value, it is likely that the person sitting on the chair is sitting straight.

In above example, one rear load cell and one front load cell are used to discriminate among different postures characterized by different weight distributions between front and rear legs. As another example, one can use load cells for all legs (three or more legs). In this manner, it is possible to discriminate between different postures on the basis of the different weight distributions between all legs, including a posture wherein the person is leaning forward while turned to the right, and a posture wherein the person is sitting straight and is turned to the left.

In yet another example, different types of detectors like a pressure sensor in the back and seat of the chair and or a tilt sensor positioned under the seat of the chair are used to discriminate among different postures characterized by differences in the pressure against the back and on the seat of the chair and by differences in the tilt angles compared to the angle when nobody is sitting in the chair. Also in this manner, it is possible to discriminate between various different postures.

Above examples have been discussed within the context of static postures. A person sitting on a chair typically changes his/her posture over time, or he/she may be using gestures during a conversation. These dynamically changing postures give rise to dynamically changing weight readings at the load cells. A dynamic weight distribution with changes on a certain time scale may be a good indication that a social interaction is taking place, e.g., a conversation.

Detectors 102-108 may therefore also include load cells in order to determine the posture of a person sitting in a particular chair. Combining the information about postures, and the dynamic changes therein, as derived from detectors specific to two or more chairs in the same area, enables to determine whether the persons are involved in a conversation.

In addition to recognizing different postures, as described above to the scenarios of using 2 load cells, also the orientation of the guest relative to the chair can be determined if 4 load cells (1 cell per leg) are being used, e.g., the guest is sits turned to the left relative to the vertical plane of symmetry of the chair, or turned to the right, or straight. Note that information about orientation and information about posture are complementary, in the sense of that all combinations of these postures and orientations are possible, some of which have been mentioned above. Information about the orientation of two guests sitting on two chairs standing closely can be used to infer the fact of conversation or a joint activity going on between these two guests (e.g., the two guests are oriented towards each other). This, in turn, can be used to support, for example, a social atmosphere by means of having server 112 also control the ambient lighting in dependence on having detected the conversation or joint activity.

The load cell-based system can also be used to detect prolonged static postures. This information can be used to infer that the guest is really engaged in an activity and should not be disturbed (e.g., sleeping or working hard behind a laptop). In contrast, if the user is moving in his/her chair relatively frequently or is changing his/her posture relatively frequently, this could mean that he/she is bored and therefore, for instance, should be served as soon as possible.

Reference is now had to FIG. 7. At the other side of the lobby two other guests 702 and 704 have arrived, who have sat down in chair 212 and on couch 206. This is detected by relevant ones of presence detectors 102-108. Server 112 registers this presence and controls map 200 accordingly. Server 112 determines from the weights registered by the load cells in chair 212 and couch 206 that guests 702 and 704 are sitting face to face. Furthermore, server 112 concludes, on the basis of the dynamic changes in the weights registered, that guests 702 and 704 are involved in a conversation. The same conclusion could also be drawn based on sound level readings, for instance based on measuring the frequency range of speech. Accordingly, server 112 controls map 200 so as to have a red region 706 appear gradually over this area of the lobby, after a pre-set time. This indicates to the wait-staff that guests 702 and 704 may need to be served. Region 706 covers both chair 212 and couch 206, as an additional annotation that guests 702 and 704 are involved in a social interaction. The attending member of the wait-staff then is notified of the fact that guests 702 and 704 would probably like to have their services synchronized, and would probably like to be approached in a non-intrusive manner. As discussed above with respect to the services to guests 302 and 504, region 706 will be assigned graphical attributes depending on the status of the service and the elapsed time guests 702 and 704 have been waiting beyond a certain pre-set time period.

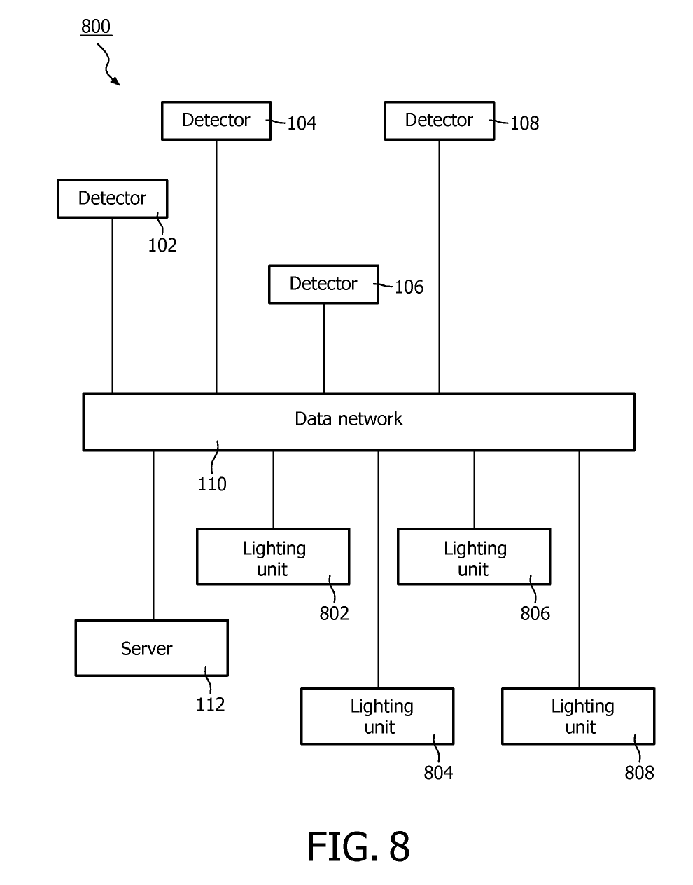

FIG. 8 is a diagram of a second system 800 in the invention. Second system 800 differs from first system 100 in that lighting units are being used at the physical locations of the guests to indicate the service status of the guests, instead of display monitors 114 and 116 that indicate the service status on a map of the premises. In the example shown, second system 800 comprises a lighting unit 802, a lighting unit 804, a lighting unit 806 and a lighting unit 808. Detector 102 controls the status of lighting unit 802 via data network 110. Detector 104 controls the status of lighting unit 804 via data network 110. Detector 106 controls the status of lighting unit 806 via data network 110. Detector 108 controls the status of lighting unit 808 via data network 110. Note that instead of using individual ones of detectors 102-108 to control individual ones of lighting units 802-808, a detector system could be used, e.g., based on one or more video cameras and Video Content Analysis as discussed above, to selectively control the status of lighting units 802-808 via data network 110. Lighting units 802-808 are accommodated at or near the locations on the premises where guests can sit down. The color, intensity or another attribute of the light emitted by a specific one of lighting units 802-808 can be used as a visual indication of the service status of the guest nearby. Indoors, lighting units 802-808 may be accommodated, for example, in the ceiling of the hall. In this case, lighting units 802-808 can be coupled to data network 110 via wired connection. Alternatively, lighting units 802-808 are accommodated at pieces of furniture. In the latter case, each individual one of lighting units 802-808 preferably comprises an individual power supply, e.g., a battery, and an individual wireless receiver for receiving via data network 110 a control signal for control of the lighting unit to visually indicate the local service status. Outdoors, for example, at an outdoor restaurant, lighting units 802-808 may likewise be accommodated at pieces of furniture and preferably comprise an individual power supplies, e.g., batteries or solar cells, and individual wireless receivers for receiving via data network 110 control signals for control of the lighting units to visually indicate the local service status. Care has to be taken to prevent the light emitted by any of lighting units 802-808 from being drowned in bright sunlight, rendering the emitted light practically invisible to the members of the staff. For example, lighting units 802-808 could be mounted at eye level of the typical waiter and so as to be recessed with respect to their housings or under projecting caps or peaks. Alternatively, lighting units 802-808 can be accommodated underneath pieces of furniture so as to illuminate the ground in the shadow of the relevant pieces of furniture.

Note that in a further embodiment of the invention, first system 100 and second system 800 are merged to form a single system, using display monitors 114-116 as well as lighting units 802-808 as generators, controlled by sever 112 to generate the indications to guide the staff of the service-oriented business.

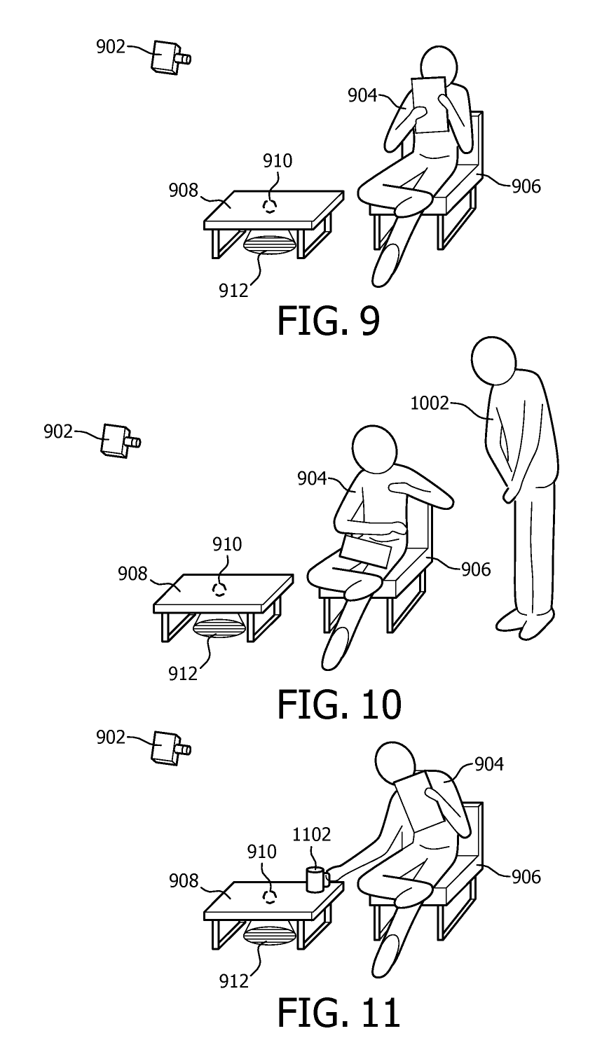

FIGS. 9, 10 and 11 are diagrams illustrating operation of second system 800. In second system 800, presence detectors 102-108 are implemented using a detector system based on a video camera 902 overlooking the premises, or part thereof. Video camera 902 is connected to server 112 via data network 110. Server 112 runs Video Content Analysis software in order to determine whether or not one or more guests are present on the premises, and at which locations. Server 112 keeps track of for how long which guest has been present at his/her location and controls visual indicators, e.g., lighting units at or near the locations of guests, and/or graphic representations on a display monitor, to indicate the service status of the individual guests to the staff. The diagram of FIG. 9 shows a relaxed guest 904 sitting in a chair 906 near a small table 908 and reading a magazine. As visual indicator a lighting unit 910 is used, mounted underneath table 908 and controlled via data network 110 by server 112. Lighting unit 910 is shown in dashed lines as it is obscured by the table top in reality from the vantage point chosen in the diagram.

As soon as server 112 has determined that guest 904 has been seated at chair 906, server 112 controls lighting unit 910 so as to change its status from “inactive” to “active”. The adjective “inactive” means, for example, that lighting unit is turned off and does not consume power, apart from a receiver part (not shown) of lighting unit 910 that is configured to receive and process control signals from server 112. The adjective “active” means, for example, that the lighting unit 910 is illuminating a spot 912 on the floor underneath table 908 with its emitted light, a color or intensity of which indicating the service status of guest 904. Alternatively, the adjective “active” means that a watchdog circuit (not shown) accommodated at lighting unit 910 and having an internal timer (not shown), is enabled. After a pre-determined time-period has elapsed according to the internal timer, the watchdog circuit turns on a light-emitting part (e.g., an LED, not shown) of lighting unit 910, the color or intensity of the emitted light being representative of the service status of guest 904.

It is assumed in the diagram of FIG. 9 that lighting unit 910 is turned on and illuminates spot 912 in a manner that signifies that a service is due to be provided to guest 904. That is, the status of lighting unit 910 signifies that a service is due to guest 904.

In the diagram of FIG. 10, a waiter 1002 has been alerted to the presence of guest 904 as a result of the status of lighting unit 910. Waiter 1002 has come over to guest 904, who thereupon eagerly orders a decent stein of a good lager.

FIG. 11 is a diagram illustrating the outcome of the order taken by waiter 1002 in the diagram of FIG. 10. After waiter 1002 has disappeared to fetch the stein, guest 904 continues reading his magazine. A short while later, waiter 1002 soundlessly materializes and disappears again, leaving a stein 1102 on table 908 within arm length of guest 904. The service status of guest 904 has now changed and lighting unit 910 is controlled to represent the changed service status by changing the attribute of the indication, e.g., the color of the light emitted by lighting unit 910. The control of lighting unit 910 can be implemented in a variety of manners.

For example, after having taken the order, waiter 1002 communicates the taking of the order, as associated with guest 904 and via a suitable interface (not shown), to server 112. A suitable interface comprises, e.g., a wireless communication device that communicates with server 112 via data network 110, or a cash register that logs the orders per guest for compiling the eventual bill and that communicates via data network 110 with server 112. When server 112 receives the message that an order was taken for guest 904, identified as residing near lighting unit 910, server 112 changes the status of lighting unit 910 via data network 110. For example, lighting unit 910 in this scenario is configured to have the light emitting part of lighting unit 910 turned off, or to have the light emitting part controlled to change the color or the intensity of the emitted light incident on spot 912.

As another example of implementing the control of lighting unit 910, waiter 1002 carries with him a short-range RF transmitter (not shown) through which waiter 1002 controls the status of lighting unit 910. Lighting unit 910 in this scenario is configured to interpret the RF signal received from the RF transmitter as that lighting unit 910 is to change its status and report the status change via data network 110 to server 112 for an update of the status as monitored by server 112.

Optionally, the intensity or the color of the light emitted by lighting unit 910 can be automatically adapted to the intensity or to the dominant color of the ambient light, in order to improve the visibility of spot 912. To this end, first system 100 or second system 800 may comprise one or more sensors (not shown), configured for sensing a dominant color and/or intensity of the ambient light, and for supplying sensor signals indicative of the color or intensity sensed, and connected to server 112 via data network 110. Upon receiving the sensor signals server 112 controls the color and/or intensity of the light emitted by lighting unit 910 so as to improve the visibility of spot 912. For example, lighting unit 910 may therefore have multiple LEDs (not shown) and a controller (not shown) to control the mixing of colors and/or the intensity of the emitted light under control of server and in dependence on the ambient light

Optionally, the color and/or intensity of the light emitted by lighting unit 910 is controlled to change over the time period during which the service status of guest 904 remains the same, in order to visually indicate to the staff a relative urgency of the service due. For example, lighting unit 910 has multiple LEDs (not shown), a timer (not shown) and a controller (not shown) to control the mixing of colors and/or the intensity of the emitted light in dependence on the time elapsed since the current service status was determined. This configuration can be used, for example, to increase the intensity of the emitted light over time.

Variations on the theme of the invention discussed above include the following. Instead of changing the colors of the regions 304, 502, 506, 602, and 706 on map 200, as visual status indications of services, one could use different indications on map 200. Examples are: a disc or ellipse, whose size grows based on the time that has passed since the relevant guest(s) sat down and did not receive service; a symbol of a person that changes color depending on the waiting time; a blinking pattern that starts after a certain time, and blinks faster when the waiting time lasts longer; a smiley type symbol, that changes from happy to angry; an hour-glass symbol or a dial face of a time piece, that resets when an action has been taken, or any other convenient icons. Different ones of such type of indication may be combined. Extra color schemes or shadings can be used.

Yet another variation on the theme is to use detectors 102-108 to control lighting and/or background music in the area, covered by the detectors, of the hospitality service-oriented business.

In first system 100 and second system 800, server 112 receives the presence detector signals from detectors 102-108, and controls the service status of the monitored guests as represented on display monitors 114-116 and/or as indicated by lighting units 802-808. Server 112 controls display monitors 114-116 and/or lighting units 802-808 in dependence on time elapsed before the guests are being served. As an option, server 112 is configured to maintain, in a memory (not shown), a service history for all guests and accumulated over time. A manager of the service-oriented business may then consult this service history in order to determine if the quality of the service, e.g., the responsiveness of the staff or efficiency of the catering service, can be improved. The quality of the service can possibly be improved, for example, by means of allocating smaller or larger clusters of guests to particular members of the staff, or by means of rearranging the furniture in a certain area for improving accessibility of the locations of the guests, or by means of changing the number of the active members of the staff in dependence on the total number of guests present at a certain time, etc. That is, the accumulated service history may provide a valuable tool to the manager to improve running his/her business.

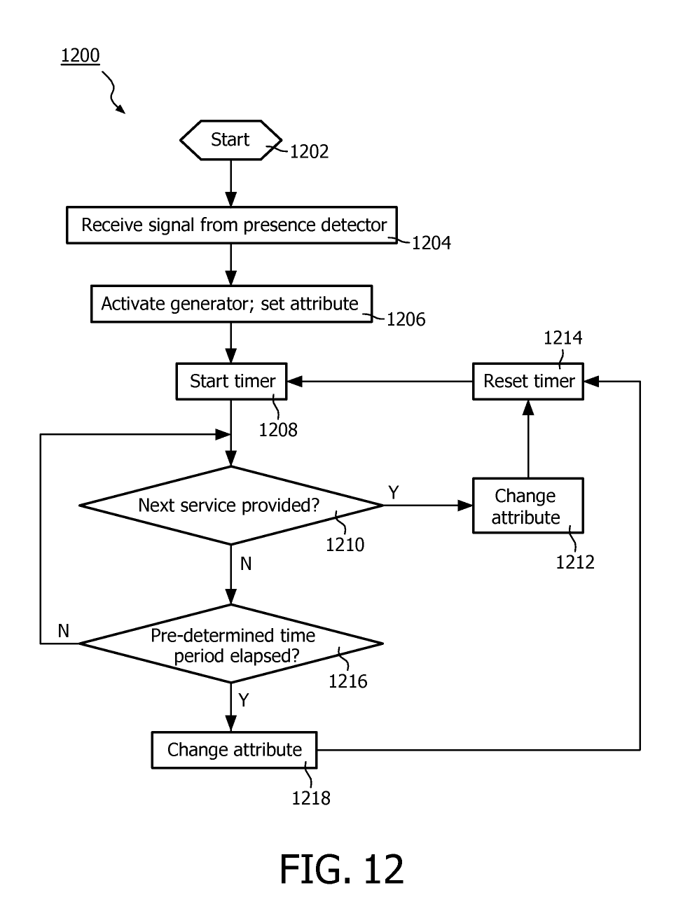

FIG. 12 is a process diagram illustrating an embodiment of a process 1200 according to a method in the invention for providing guidance to a staff of a service-oriented business for attending to a guest on the premises of the business. Process 1200 starts with a first step 1202. In a second step 1204, a signal is received from a presence detector, e.g., detector 102. The signal received from presence detector 102 is representative of a presence of the guest at a pre-determined location on the premises. In a third step 1206, a generator is activated. The generator comprises, e.g., lighting unit 802 or display monitor 114. In case the generator comprises lighting unit 802, the generator is activated, e.g., by means of starting the supply of power to lighting unit 802 through a switch controlled by server 112 via data network 114. Lighting unit 802 is set in a stand-by mode, and prepared for generating the human-perceptible indication when commanded to do so by server 112. Alternatively, server 112 commands lighting unit 802 to turn on the light-emitting part of lighting unit 802 for emitting light with an attribute (e.g., color, intensity) representative of the current service status: for example, service is due. In case the generator comprises display monitor 114, the generator is activated by, e.g., means of receiving from server 112 a command to render on a displayed map of the premises a graphics representation of the newly arrived guest to indicate the guest's presence. Optionally, a color, size, or flashing frequency of the graphics representation is used to indicate that a service is due to this guest.

In a fourth step 1208, a timer is started to keep track of the time elapsed before a service is actually provided to the guest.

In a fifth step 1210, it is determined whether or not a service has been provided to the guest. Whether or not a service has been provided can be determined, for example, by determining whether or not a member of the staff has approached this guest. As mentioned above, this determining can be implemented through Video Content Analysis, or through the member of the staff actively communicating with the guidance system through an RF beacon or through holding an RFID tag near a sensor installed near the guest, etc.

If it is determined in fifth step 1210 that a service has been provided, the attribute of the indication is changed in a sixth step 1212. For example, in case the generator comprises lighting unit 802, the light-emitting part of lighting unit 802 is turned off, or the color or intensity of the emitted light is subdued. In case the generator comprises display monitor 114, the graphics representation is removed, or the graphics attributes, e.g., color, intensity, or shading, are altered to soften the appearance to the eye of the member of the staff. The change in the attribute is to signify that the guest has been served and that a next service is not immediately due. After sixth step 1212, process 1200 proceeds with a seventh step 1214 to reset the timer. After seventh step 1214, process 1200 returns to fourth step 1208.

If it is determined in fifth step 1210 that a service has not yet been provided to the guest, process 1200 proceeds with an eighth step 1216.

In eighth step 1216, it is determined whether or not the timer has expired, i.e., whether or not a pre-determined length of time has elapsed since the timer was started in fourth step 1208. If it is determined in eighth step 1216 that the timer has not yet expired, process 1200 returns to fifth step 1210. If it is determined in eighth step 1216 that the timer has expired, process 1200 proceeds with a ninth step 1218.

In ninth step 1218, the attribute of the indication is changed. The change is to signify to the staff that a service to the guest is now due or overdue. For example, the light-emitting part of lighting unit 802 is turned on in case the service is due, or the intensity of the light, emitted by the light-emitting part of lighting unit 802 is increased and/or the color is changed to indicate that the service is overdue. In case the generator comprises display monitor 114, a graphics representation of the presence of the guest appears on the map displayed on display monitor 114, or the color, shading or perceived brightness of the graphics representation is changed to be more noticeable by the staff if the service is overdue. After ninth step 1218, process 1200 returns to seventh step 1214.

1. A method (1200) of providing guidance to a staff of a service-oriented business for attending to a guest (904) on the premises of the business, the method comprising:
receiving (1206) from a presence detector a signal representative of a presence of the guest at a pre-determined location on the premises;
determining (1216) a length of a time period during which the guest has been present at the pre-determined location; and
generating (1218) a human-perceptible indication of the presence of the guest at the pre-determined location, wherein the indication has an attribute that changes with the passing of time.

2. The method of claim 1, wherein:
the indication comprises a visual signal;
the attribute comprises at least one of a color of the visual signal or an intensity of the visual signal; and
the indication is generated at least at one of:
a display monitor (114, 116); and
a specific one of multiple lighting units (802, 804, 806, 808; 910) that is near a specific location of the guest on the premises.

3. The method of claim 1, comprising enabling to modify the attribute under control of at least one of the following:
detecting a presence of a member of the staff near the guest;
receiving a communication from a communication device of a member of the staff near the guest;
a type of service provided to the guest, as indicated in a communication received from a communication device of a member of the staff.

4. The method of claim 1, wherein the attribute is representative of a service due to the guest.

5. A guidance system (100; 800) for providing guidance to a staff of a service-oriented business for attending to a guest (904) on the premises of the business, wherein the system comprises:
a presence detector (102, 104, 106, 108; 902) configured for supplying a signal representative of a presence of the guest at a pre-determined location on the premises;
a timer, coupled to the presence detector and configured for determining a length of a time period during which the guest has been present at the pre-determined location; and
a generator (114, 116; 802, 804, 806, 808; 910) coupled to the timer for generating a human-perceptible indication of the presence of the guest at the pre-determined location, wherein the indication has an attribute that changes with the passing of time.

6. The guidance system of claim 5, wherein:
the indication comprises a visual signal;
the attribute comprises at least one of a color of the visual signal or an intensity of the visual signal; and
the generator comprises at least one of
a display monitor (114, 116); and
a specific one of multiple lighting units (802, 804, 806, 808; 910) that is near a specific location of the guest on the premises.

7. The guidance system of claim 5, configured for modifying the attribute under control of at least one of the following:
detecting a presence of a member (1002) of the staff near the guest;
receiving a communication from a communication device of a member of the staff near the guest;
a type of service provided to the guest, as indicated in a communication received from a communication device of a member of the staff.

8. The guidance system of claim 5, wherein the attribute is representative of a service due to the guest.
